(19) United States
(12) Patent Application Publication
(10) Pub. No.: US 2024/0418633 A1
(43) Pub. Date: Dec. 19, 2024

(54) COMBINATION OF MULTIWAVELENGTH RAMAN AND SPECTROSCOPIC ELLIPSOMETRY TO MEASURE A FILM STACK

(71) Applicant: KLA Corporation, Milpitas, CA (US)

(72) Inventors: Shova Subedi, San Jose, CA (US); Shankar Krishnan, Cupertino, CA (US); Qiang Zhao, Milpitas, CA (US); Ming Di, Pleasanton, CA (US); Carlos L. Ygartua, San Jose, CA (US); Mikhail Sushchik, Pleasanton, CA (US)

(21) Appl. No.: 18/232,337

(22) Filed: Aug. 9, 2023

Related U.S. Application Data
(60) Provisional application No. 63/521,555, filed on Jun. 16, 2023.

(51) Int. Cl. G01N 21/21; G01B 11/06; G01N 21/65; G01N 21/84; G01N 21/95; G01N 23/22

(52) U.S. Cl. CPC G01N 21/211; G01B 11/0641; G01N 21/65; G01N 21/8422; G01N 21/9501; G01N 23/22; G01B 2210/56; G01N 2223/1016; G01N 2223/61; G01N 2223/6116; G01N 2223/633

(57) ABSTRACT

A thickness of a film stack of a workpiece and a composition of the film stack is determined with an x-ray technique, spectroscopic ellipsometry (SE) and/or spectroscopic reflectometry (SR), and multiwavelength Raman spectroscopy. The measurements are combined to form combined measured data. The combining includes regressing the second measurements and the third measurements. The thickness of the film stack and the composition of the film stack is then determined using the combined measured data.

### CROSS-REFERENCE TO RELATED APPLICATIONS

This application claims priority to the provisional patent application filed Jun. 16, 2023 and assigned U.S. App. No. 63/521,555, the disclosure of which is hereby incorporated by reference.

### FIELD OF THE DISCLOSURE

This disclosure relates to measuring a film stack on a workpiece, such as a semiconductor wafer.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Metrology processes also are used at various steps during semiconductor manufacturing to monitor and control the process. Metrology processes are different than inspection processes in that, unlike inspection processes in which defects are detected on workpieces, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

In-line optical metrology techniques can include spectroscopic ellipsometry (SE) and spectroscopic reflectometry (SR). SE is an optical measurement technique that measures the change in polarization of the outgoing light reflected from the sample, such as a workpiece. SE can measure parameters like thickness, optical constants such as refractive index and extinction coefficients (n and k), material properties such as crystallinity, surface roughness, alloy composition, anisotropy, or other parameters. SE can be robust technique to measure critical parameters for the thin film or multiple film stacks, but SE is less sensitive when measuring strain.

Raman scattering is based on the inelastic scattering of the incident light by optical phonon or molecular vibration of the sample, such as a workpiece. It measures the change in frequency of the outgoing light relative to the incoming or impinging light frequency that is caused by scattering. It can quantify the material properties like material species, its chemical nature, crystallinity, stress/strain, concentration, or other parameters. Raman peak positions and full-width-at-half-maximum (FWHM) of the Raman peaks can be used to estimate the concentration and thicknesses. Also, change or shift in Raman scattered energy can reveals stress/strain of the sample.

Manufacturers are reaching physical limits when shrinking transistors, so manufacturers are adding SiGe alloys, SiC, GaN, or other material to increase the strain of the Si channels, which improves and allows selective control of the mobility of the carriers. Continued scaling and performance enhancement through introduction of new materials and structures will increase complexity. Non-destructive in-line monitoring techniques that are fast and can monitor sub-micrometer spot size are needed. A probing volume depends on the spot size and penetration depth, which in turn depends on the wavelength of the laser. This can be performed using high-resolution multiwavelength (MWL) Raman.

Transistor performance will be improved by reducing the dimensions, using new device structures like a gate-all-around FET (GAA FET) or complementary FET (CFET), and performing electrostatic control using stress of the channels. The current technique to monitor GAA FET devices or a film is based on multi-angle broad band SE in combination with reflectometry. SE can be useful in characterizing the composition of single layer or multilayer with high material contrast. The measured spectra are fitted to a theoretical optical model in the broadband wavelength range where film parameters like n, k, and thickness of a single layer or complex multilayer stacks thickness can be determined. This fitting can be complicated for multilayer film stacks and may be unable to characterize the defect, strain, and interfacial diffusion. The previous technique is limited when measuring a multilayer stack with small material contrast and graded layer. Such a situation can require an accurate model to describe the layers. The deeper layer may have higher uncertainty when measuring the film parameters.

Other thickness and material measurement analysis techniques, such as x-ray reflectometry (XRR), x-ray fluorescence (XRF), x-ray diffraction (XRD), scanning electron microscopy (SEM), or transmission electron microscopy (TEM), can be used. Although these are reliable techniques and can measure thickness, stress, and composition, these are not suitable in-line measurements because each is slow and/or destructive.

TEM and other electron diffraction-based technologies can be used for strain and thickness measurements and can probe up to a several nm spot. These techniques are time-consuming, destructive, and require sample preparation, which may influence strain characteristics. Non-destructive technique like XRD or XRR are slow and have a large spot size up to a few mm, which is not suitable for in-line process monitoring. Another technology, secondary ion mass spectrometry (SIMS), can be used for depth profiling, but is intrinsically destructive, time-consuming, and has a large spot size (e.g., approximately 100 μm). Optical SE could measure the total or individual thickness of a multiple-layer thin film stack accurately. However, SE alone cannot determine the thicknesses of the multilayer stack and may need an accurate model to characterize underlying film stacks. Furthermore, SE or laser driven spectroscopic reflectometer (LDSR) cannot provide with the strain in the stacks.

Therefore, new techniques and systems are needed.

### BRIEF SUMMARY OF THE DISCLOSURE

A method is provided in a first embodiment. The method includes measuring a thickness of a film stack of a workpiece and a composition of the film stack using an x-ray technique thereby generating first measurements. The x-ray technique is x-ray diffraction (XRD), x-ray reflectometry (XRR), or a soft x-ray technique. The thickness of the film stack and the composition of the film stack is measured using spectroscopic ellipsometry (SE) and/or spectroscopic reflectometry (SR) thereby generating second measurements. The thickness of a film stack and the composition of the film stack also is measured using multiwavelength Raman spectroscopy thereby generating third measurements. The second measurements and the third measurements are combined to form combined measured data. The combining includes regressing the second measurements and the third measurements. The thickness of the film stack and the composition of the film stack is determined using the combined measured data.

The method can include measuring a strain of the film stack using the x-ray technique.

The method can include adjusting accuracy of the SE and/or SR using the thickness and the composition of the film stack measured with the x-ray technique.

The method can include adjusting accuracy of the multiwavelength Raman spectroscopy using the thickness and the composition of the film stack measured with the x-ray technique.

The combining can include combining the first measurements with the second measurements and the third measurements.

The combining and the determining can use a physical model. The combining and the determining also can use a machine-learning algorithm.

The film stack may be a Si/SiGe film stack, a Si/SiC film stack, or a Si/GaN film stack.

The workpiece may include a GAA FET, FinFET, ForkFET, CFET, or 2D structure.

The second measurements and the third measurements can further include strain, stress, and/or defects.

The second measurements and the third measurements may be performed at least partly simultaneously. For example, the first measurements are performed at least partly simultaneously with the second measurements and the third measurements.

A non-transitory computer-readable storage medium is provided in a second embodiment. The non-transitory computer-readable storage medium includes one or more programs for executing the following steps on one or more computing devices. First measurements that include a thickness of a film stack of a workpiece and a composition of the film stack measured using an x-ray technique are received. The x-ray technique is XRD, XRR, or a soft x-ray technique. Second measurements that include the thickness of the film stack and the composition of the film stack measured using SE and/or SR are received. Third measurements that include the thickness of the film stack and the composition of the film stack measured using multiwavelength Raman spectroscopy are received. The second measurements and the third measurements are combined to form combined measured data, wherein the combining includes regressing the second measurements and the third measurements. The thickness of the film stack and the composition of the film stack are determined using the combined measured data.

The combining can further include combining the first measurements with the second measurements and the third measurements.

The combining and the determining can use a physical model. The combining and the determining also can use a machine-learning algorithm.

The second measurements and the third measurements further may include strain, stress, and/or defects.

A system is provided in a third embodiment. The system includes an x-ray measurement unit configured to measure a thickness of a film stack of a workpiece on a stage and a composition of the film stack thereby generating first measurements. The x-ray measurement unit uses XRD, XRR, or a soft x-ray technique. An SE/SR measurement unit is configured to measure the thickness of the film stack and the composition of the film stack thereby generating second measurements. A multiwavelength Raman spectroscopy unit is configured to measure the thickness of the film stack and the composition of the film stack thereby generating third measurements. A processor is in electronic communication with the x-ray measurement unit, the SE/SR measurement unit, and the multiwavelength Raman spectroscopy unit. The processor is configured to combine the second measurements and the third measurements to form combined measured data and determine the thickness of the film stack and the composition of the film stack using the combined measured data. The combining includes regressing the second measurements and the third measurements.

The x-ray measurement unit can be further configured to measure a strain of the film stack.

The processor can be further configured to adjust accuracy of the SE/SR measurement unit and/or the multiwavelength Raman spectroscopy unit using the thickness and the composition of the film stack in the first measurements.

The processor can be further configured to combine the first measurements with the second measurements and the third measurements.

The combining and the determining can use a physical model and/or a machine-learning algorithm.

The second measurements and the third measurements may further include strain, stress, and/or defects.

The second measurements and the third measurements may be performed at least partly simultaneously. For example, the first measurements are performed at least partly simultaneously with the second measurements and the third measurements.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram showing an exemplary layout of Raman spectroscopy;

FIG. 2 illustrates exemplary laser excitation at different wavelengths probing up to different film stacks;

FIG. 3 illustrates corresponding spectra forms for FIG. 2;

FIG. 4 is an exemplary measured spectra as a function of a dispersion model x%_{Raman} and ε_{Raman}≈x%ᵣ and εᵣ and x%_{SE} and t_{SE}≈x%ᵣ and tᵣ;

FIG. 5 is a diagram showing an exemplary layout of spectroscopic ellipsometry;

FIG. 6 is a flow chart of a method in accordance with the present disclosure;

FIG. 7 is another flow chart of a method in accordance with the present disclosure; and

FIG. 8 is an exemplary system in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein use multiple non-destructive optical spectroscopic and metrology techniques such as multiwavelength (MWL) Raman, SE, spectroscopic reflectometry (SR), and/or angle resolved spectroscopic reflectometer (i.e., a beam profile reflectometer (BPR)). Embodiments disclosed herein include combining these techniques to characterize critical parameters of unpatterned and patterned multilayer structures. This not only includes film applications, but also covers device structures in-die and device like critical dimension (CD) structures in scribe lines and device structures. These optical techniques can characterize the film stacks in terms of the composition and strain as well as perform the depth profiling of single and multilayer film stacks. SE and SR tend to have less sensitivity to buried structures and can benefit from the independent information such as composition and strain obtained from MWL to improve the SE model.

Each technique can separately measure some or all the film properties (e.g., composition, strain, thickness), but multiple techniques can complement each other in combination and can improve the accuracy and precision of the measured components. In addition, by training machine learning (ML) models using measured spectra through deep learning then a neural network analysis can help to measure film parameters efficiently.

To overcome limitations of current techniques and improve the accuracy of measurements, the sample spectra can be to be compared and tested with the reference technology results. Thickness, composition, and optionally the strain of the sample film stack can be measured using reference x-ray technology (e.g., x-ray diffraction (XRD), x-ray reflectometry (XRR), or a soft x-ray (SXR) technique). The derived thickness, composition, and strain can be used in SE and Raman to improve its accuracy and precision. While disclosed specifically with an x-ray technique, other techniques that provide relevant reference data can be used.

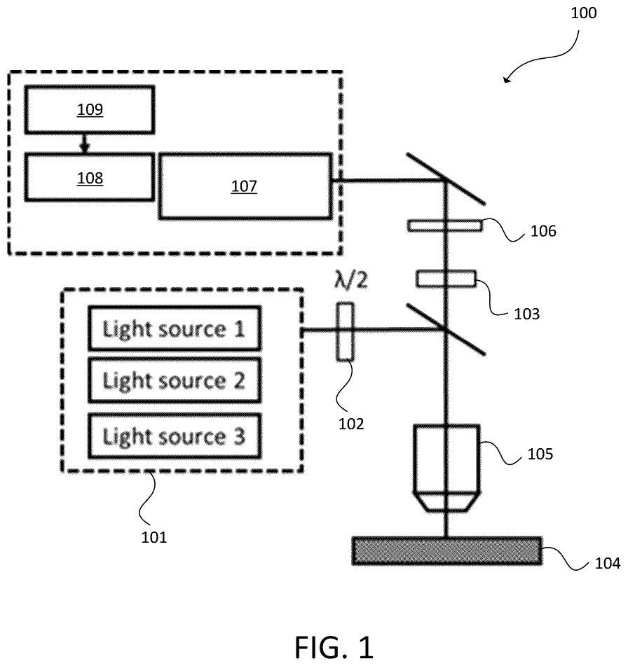

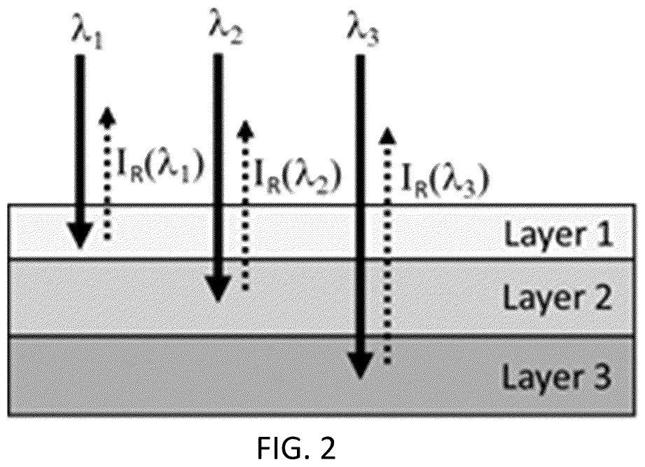

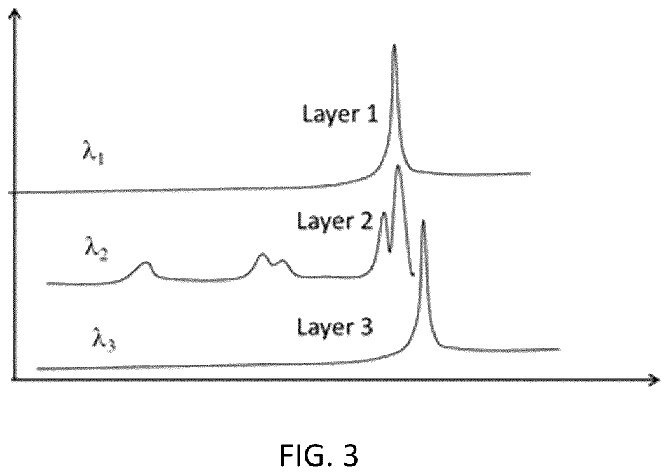

Raman spectroscopy is sensitive to the composition and stress of the Raman active material. FIG. 1 is a typical layout for a Raman spectroscopy system 100 that includes multiple laser excitation sources (in the light source 101), a polarization assembly 102, an analyzer rotation assembly 103, and objective 105, and a laser line filter 106. The stress or strain of the sample 104 (e.g., the workpiece, which can be a semiconductor wafer) can change the well-defined Raman band, lift the degeneracy, and shift the band position. This can change the band shape and distort the symmetry of the band. A spectrometer 107 and detector 108 is used with a controller 109 (which can include a processor) to determine measurements. A material on or in the sample 104 has a different absorption coefficient at different wavelengths and can interact up to certain depth in the absorbing medium. The shorter wavelength can probe shallow layers while changing to longer wavelength can enable selective probing of certain layers, which is depicted in the FIG. 2. This can result in different Raman profiles for different wavelengths, as shown in FIG. 3. A Raman signal from each excitation comes from the interacted volume in the film layers and its profile has the characteristic feature of those layers. Depending on the wavelength of excitation, the Raman signal I_{R}(1) has a different peak position and profile, which can provide the composition (x) and strain (ϵ) of the layer. Also, I_{R}(1) can be a function of material properties like refractive index (n), extinction coefficient (k), thickness, strain, or other parameters and the response can be different for different wavelength excitations.

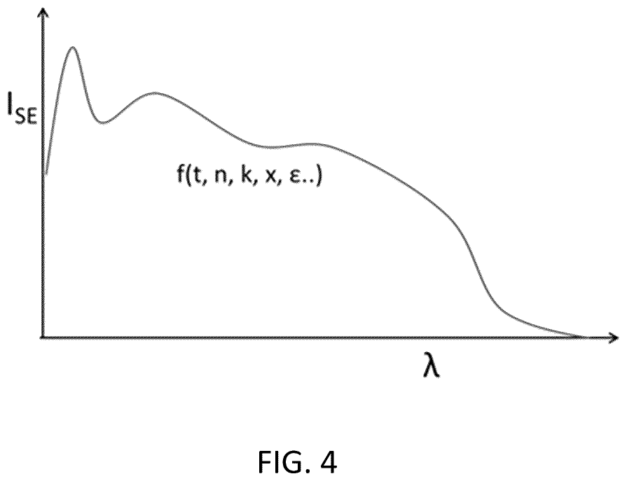

Similarly, SE and SR spectra may depend on the dispersion of the material over the wavelength range. FIG. 4 is a typical SE spectra where intensity is a function of different film parameters. Broadband spectroscopic ellipsometry (BBSE) can cover single angle of incidence (AOI), such as 65 degrees, or multiple AOIs ranging from 0 to 90 degrees. Ellipsometry covers all the types of ellipsometry such as rotating analyzer/polarizer ellipsometry, rotating compensator and compensators, or a combination of rotating analyzer/polarizer/compensators. The BBSE signal includes, but is not limited to, tan Ψ, cos Δ, harmonics, Mueller matrix, or Stokes vectors. Based on the reference t and x%, the SE and SR model can be optimized and tested so that the model fits the measured spectra with the value of reference thickness and composition. The combination of BBSE and Raman technologies can be measured sequentially or simultaneously. For the simultaneous measurements, BBSE can act as a modulation to the sample and can add additional sensitivity to Raman signal. The experimental setup can have modulation on and off of the combination and can use the Raman response difference to determine sample properties such as strain, composition, and/or thicknesses of the multiple film stack.

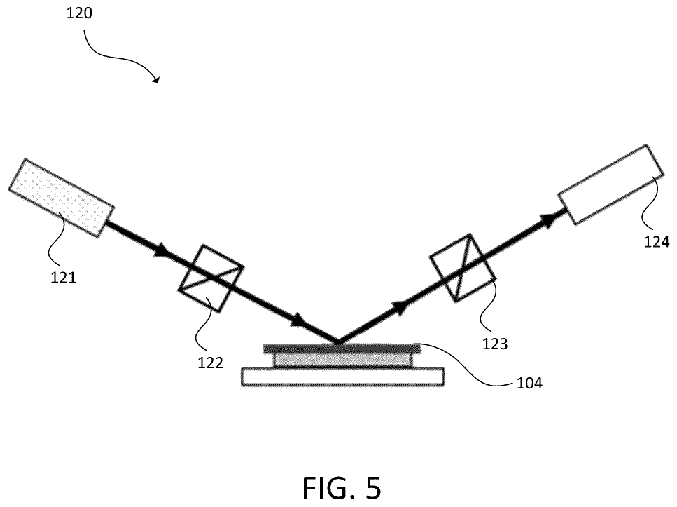

FIG. 5 is a typical layout for SE. The SE system 120 includes a light source 121 that direction a beam through a polarizer 122 at the sample 104. Light reflected from the sample 104 is received by the analyzer 123 and then the SE spectrometer 124. The distribution of light across the optical spectrum can be measured to show the interaction between the light and the sample 104.

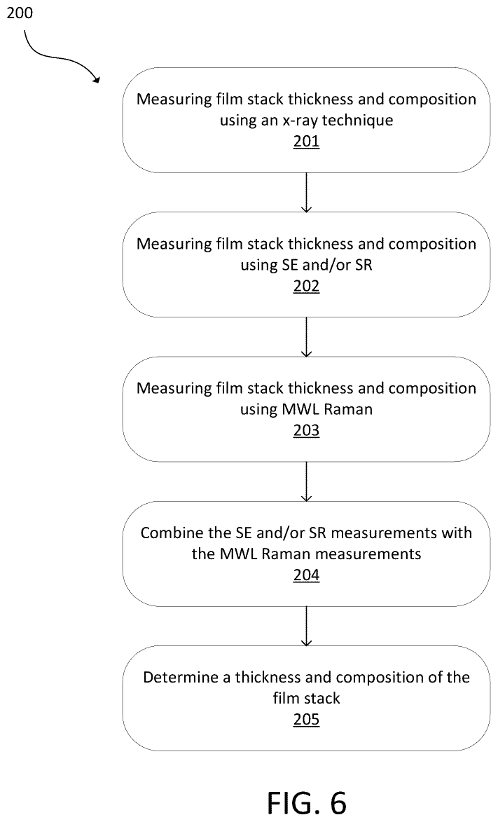

FIG. 6 shows an embodiment of the method 200. A thickness and/or composition of a film stack of a workpiece is measured at 201 using an x-ray technique, which generates first measurements. The x-ray technique can be x-ray diffraction (XRD), x-ray reflectometry (XRR), or a soft x-ray technique. The first measurements can be used as a reference. The strain of the film stack optionally also can be measured with the x-ray technique.

While an x-ray technique is described to generate a reference, the reference can be generated using other techniques. For example, TEM, SEM, or XRF can be used to generate the reference. A user, such as a semiconductor manufacturer, also can provide the reference information.

The film stack can be, for example, a Si/SiGe film stack, a Si/SiC film stack, or a Si/GaN film stack. The workpiece can include, for example, a GAA FET, FinFET, ForkFET, CFET, or 2D structures. Thin films that involve wafer bonding, such as Si/SiN, also can benefit from the embodiments disclosed herein. Other 2D FET, 3D structures, patterned structures, or film stacks on the workpiece are possible and can be used with the method 200.

At 202, the thickness and/or composition of the film stack is measured using SE and/or SR, which generates second measurements. The particular configuration used for the measurements depends on the application requirements, such as selecting from angle-resolved ellipsometer and reflectometer, single wavelength, multiwavelength, or spectroscopic parameters.

At 203, the thickness and/or composition of the film stack is measured using MWL Raman spectroscopy, which generates third measurements. The particular configuration used for the measurements depends on the application requirements.

Before steps 202 and 203 or for future measurements, the accuracy of the SE and/or SR measurements and/or the MWL Raman spectroscopy measurements can be adjusted using the thickness or composition of the film stack in the first measurements.

At least the second measurements and the third measurements are combined at 204, which forms combined measured data. The combining can include regressing the second measurements and the third measurements. The combining also can include combining the first measurements with the second measurements and the third measurements. The thickness of the film stack and/or the composition of the film stack are determined at 205 using the combined measured data. The combining and the determining can use a physical model or a machine-learning algorithm.

In an embodiment, the second measurements and the third measurements can further include strain, stress, and/or defects. In an instance, the second measurements and third measurements include strain, stress, and defects. These measurements can be used in later steps. The method 200 also can be used to determine strain, stress, and/or defects of the film stack. An x-ray technique can be used to generate corresponding reference information for strain, stress, composition, and thickness. Reference information about the defects also can be generated using a TEM.

In an instance, reference information is included for each of the types of measurements in the second measurements and third measurements. In another instance, reference information only includes some of the types of measurements in the second measurements and third measurements if the model includes the corresponding information.

In an instance, the second measurements and the third measurements are performed at least partly simultaneously. The first measurements can be performed separately from or at least partly simultaneously with the second measurements and the third measurements.

The number of the second measurements and the third measurements that are used may depend on sensitivity of the measurements.

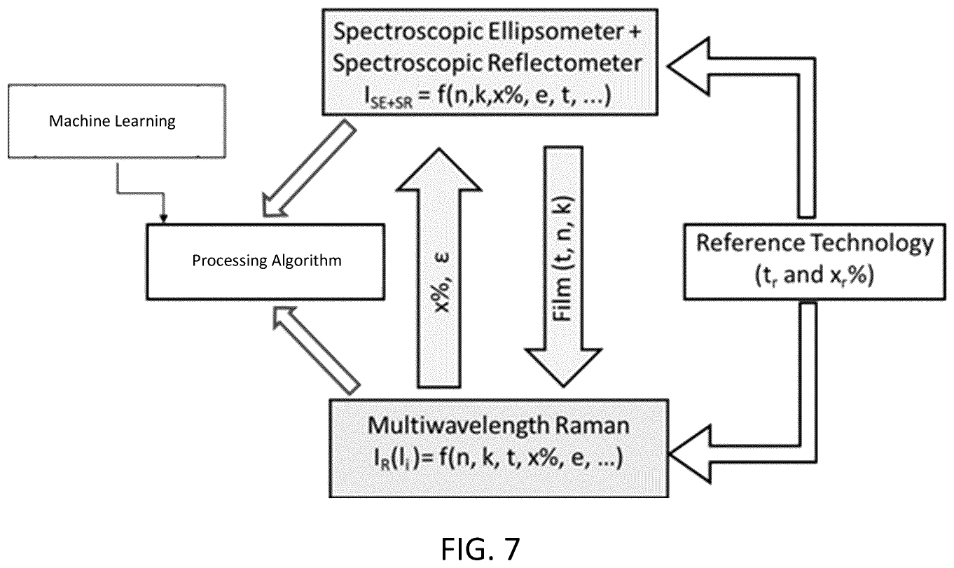

A theoretical model for Raman scattering and SE may use the theory of light propagation and scattering that can be described by using transfer matrix method. The propagation of light in the film stacks for Raman scattering and for SE and SR are the function of same film parameters and can use a combined model to delineate. In the combined and optimized physical model for SE and Raman technologies, measured data can be further regressed to and fed back and forth to obtain the film stack parameters combined. FIG. 7 shows a process flow chart of the steps. Composition and strain from reference technologies (x%ᵣ, εᵣ) like (XRD, XRR, SXR, etc.) are generally similar to that from Raman (x%_{Raman}, ε_{Raman}). There can be an offset and slope for the optimized Raman model. Similarly, thickness and composition from SE (x%_{SE}, t_{SE}) and the reference (x%ᵣ, tᵣ) tend to be the same. Usually, these are set to reference values when optimizing the SE and Raman model. For example, the reference values can be provided using an x-ray technique.

In one embodiment, the system may be configured to use the second measurements and the third measurements to determine one or more properties of the sample by combining the measurements. In an instance, combining the second measurements and the third measurements includes using all the measurements as constraints with appropriate relative weighting in a non-linear regression. In another instance, combining the second measurements and the third measurements includes using one wavelength range from one measurement technology to first determine one parameter such as thickness and then using another wavelength range from another measurement technology to determine another parameter or parameters such as refractive index. In addition, generic algorithms can be used to combine the results from multiple measurement subsystems. Many different algorithms can be used individually or in combination to extract the results from the data. In one embodiment, the one or more properties may be determined using one or more algorithms. The one or more algorithms may include a generic algorithm, a non-linear regression algorithm, a comparison algorithm (e.g., comparison with a database (or library) or pre-computed or pre-measured results), or a combination thereof. Many such algorithms are known in the art, and the processor may use any of these algorithms to determine the one or more properties. Examples of generic algorithms are illustrated in U.S. Pat. Nos. 5,953,446 and 6,532,076, which are incorporated by reference in their entireties. In one embodiment, the first and second data may include scatterometry data. In such an embodiment, it may be particularly advantageous to determine the one or more properties of the sample using one or more algorithms.

The combining and regression actions can be repeated for one or more cycles. The combining and regression actions may be repeated until a convergence condition is satisfied.

Machine learning can be used in an embodiment of the processing algorithm to determine thickness and/or composition of the film stack. The machine learning algorithm can be trained with both measured (e.g., ellipsometry and Raman spectroscopy) data and/or theoretical models. The theoretical models referred to here are the optical and EM models that provide a theoretical prediction of measured signals/spectra, based on defined geometry and materials of the sample and the parameters characterizing device optical and electronics hardware. The flow chart in FIG. 7 includes physics-based calculation model and a machine learning algorithm (i.e., a combination of regression plus machine learning (ML) models, deep learning, and/or neural networks). The physics-based calculation models use mathematical formulas to determine variables, such as thickness or composition. The measured and calculated results using both technologies can be used to create a library and can simulate and train the machine learning algorithm further. The processor can learn from different data and can help estimate the small variation in the film properties.

While other machine learning models are possible, a neural network or deep learning model is used for machine learning in an embodiment. Machine learning can be used with the theoretical models or can be used as a standalone technique if enough reference data is provided. As shown in FIG. 7, the machine learning algorithm can provide input for the processing algorithm.

Embodiments disclosed herein can use a combination of multiple technologies (e.g., single wavelength reflectometers and ellipsometers, angle-resolved reflectometers and ellipsometers, MWL Raman, SE, SR, and/or angle resolved reflectometry) using a physics-based model and combination regression (which includes machine learning feeding into the regression) can be used to solve film parameters such as thickness, composition, strain, stress, defect, etc. of superlattice structures like Si/SiGe, Si/SiC, or Si/GaN stacks. The defect can be, for example, a crystalline lattice defect or another defect that affects the optical properties of a material.

Embodiments disclosed herein can use a wide tunable narrow linewidth to selectively probe different depths and add capability to perform depth profiling.

Embodiments disclosed herein can use can directly measure both film and patterned structures on the workpiece, such as for GAA FET, FinFET, ForkFET, CFET, or 2D material applications.

Embodiments disclosed herein are non-destructive and can monitor in-line semiconductor processes. In an instance, each measurement can take from 1-5 seconds.

Polarization-dependent Raman can be sensitive to the anisotropy of the film and device patterns. Adding SE and SR can increase the accuracy because these measurement techniques are less sensitive to the anisotropy of the film.

It will be understood that, while exemplary features of a method have been described, such an arrangement is not to be construed as limiting the disclosure to such features. The method may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, quantum computer, workstation, minicomputer, or mainframe computer. The steps of the method may be implemented by a server or computer in which the software modules reside or partially reside. The computer or computers may be part of a metrology tool or a standalone computer. The computer or computers may be online or offline. The processing requirements for the computer or computers may be based on the tool throughput and time-to-solution targets.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s), i.e. of the control system, may be programmed to perform the functions of an embodiment of the method described herein. The processor(s) is a hardware device for executing software, particularly software stored in memory. Processor(s) can be any custom made or commercially available processor, a primary processing unit (CPU), an auxiliary processor among several processors associated with a computer, a semiconductor-based microprocessor (in the form of a microchip or chip set), a macro-processor, or generally any device for executing software instructions.

Memory is associated with processor(s) and can include any one or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example, the software in memory includes the one or more components of the method and is executable on a suitable operating system (O/S).

The present disclosure may include components provided as a source program executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object-oriented programming language, which has classes of data and methods, or (b) a procedural programming language, which has routines, subroutines, and/or functions, for example but not limited to, C, C++, Pascal, Basic, Fortran, Cobol, Ped, Java, and Ada.

An additional embodiment relates to a non-transitory computer-readable medium storing program instructions executable on a controller for performing a computer-implemented method for determining measurements of a workpiece, as disclosed herein. In particular, a memory may contain non-transitory computer-readable medium that includes program instructions executable on a processor. The computer-implemented method may include any step(s) of any method(s) described herein, including method 200. The steps can include: receiving first measurements that include a thickness of a film stack of a workpiece and a composition of the film stack measured using an x-ray technique (e.g., XRD, XRR, or a soft x-ray technique); receiving second measurements that include the thickness of the film stack and the composition of the film stack measured using SE and/or SR; receiving third measurements that include the thickness of the film stack and the composition of the film stack measured using multiwavelength Raman spectroscopy; combining the second measurements and the third measurements to form combined measured data; and determining the thickness of the film stack and the composition of the film stack using the combined measured data. The combining includes regressing the second measurements and the third measurements. A physical model and/or a machine learning algorithm can be used for the combining. First measurements also can be combined with the second measurements and the third measurements. Strain, stress, and/or defects can be included with the second measurements and the third measurements.

A system can be used to perform the measurements and determine a thickness, composition, or other information about a film stack of a workpiece. The system can include an x-ray measurement unit, an SE/SR measurement unit, and a multiwavelength Raman spectroscopy unit. The system can include multiple independent measurement systems or can be a cluster tool with multiple measurement systems. The x-ray measurement unit is configured to measure a thickness, composition, and/or strain of a film stack of a workpiece on a stage thereby generating first measurements. The x-ray measurement unit uses XRD, XRR, or a soft x-ray technique. The SE/SR measurement unit is configured to measure the thickness or composition of the film stack thereby generating second measurements. The multiwavelength Raman spectroscopy unit configured to measure the thickness or composition of the film stack thereby generating third measurements. Strain, stress, and or defects also can be measured to be part of the measurements.

A processor is in electronic communication with the x-ray measurement unit, the SE/SR measurement unit, and the multiwavelength Raman spectroscopy unit. The processor is configured to combine the second measurements and the third measurements to form combined measured data and then determine the thickness of the film stack and/or the composition of the film stack using the combined measured data. The combining includes regressing the second measurements and the third measurements. A physical model and/or a machine learning algorithm can be used for the combining. The first measurements optionally can be combined with the second measurements and the third measurements to determine the thickness and/or composition.

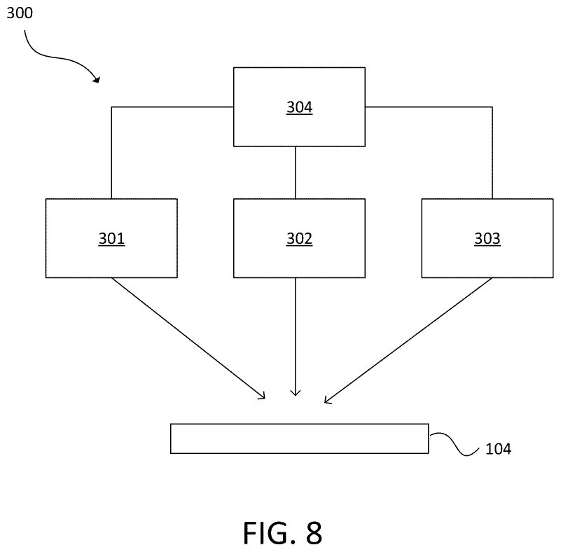

An example of a system 300 is shown in FIG. 8. The system 300 includes an x-ray measurement unit 301, an SE/SR measurement unit 302, and a multiwavelength Raman spectroscopy unit 303 that measure the sample 104. The x-ray measurement unit 301, SE/SR measurement unit 302, and multiwavelength Raman spectroscopy unit 303 are in electronic communication with the processor 304.

In an instance, the processor is configured to adjust accuracy of the SE/SR measurement unit and/or the multiwavelength Raman spectroscopy unit using the thickness and the composition of the film stack in the first measurements. For example, the processor can send instructions to adjust an optical component or change the measurement technique to improve accuracy.

The second measurements and the third measurements can be performed at least partly simultaneously on the workpiece. The first measurements also can be performed at least partly simultaneously with the second measurements and the third measurements. Of course, the first measurements, second measurements, and third measurements also can be performed sequentially. While described as first, second, and third, the measurements can be taken in a different order.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

1. A method comprising:
measuring a thickness of the film stack and a composition of a film stack of a workpiece using spectroscopic ellipsometry (SE), spectroscopic reflectometry (SR), and/or angle resolved reflectometry (ARR) thereby generating first optical measurements;
measuring the thickness of a film stack and the composition of the film stack using multiwavelength Raman spectroscopy thereby generating second optical measurements;
combining the first optical measurements and the second optical measurements to form combined measured data, wherein the combining includes regressing the first optical measurements and the second optical measurements; and
determining the thickness of the film stack and the composition of the film stack using the combined measured data.

2. The method of claim 1, further comprising measuring a strain of the film stack.

3. (canceled)

4. (canceled)

5. The method of claim 1, wherein the combining further includes combining reference measurements with the first optical measurements and the second optical measurements.

6. The method of claim 1, wherein the combining and the determining use a physical model.

7. The method of claim 1, wherein the combining and the determining use a machine-learning algorithm.

8. The method of claim 1, wherein the film stack is a Si/SiGe film stack, a Si/SiC film stack, or a Si/GaN film stack.

9. The method of claim 1, wherein the film stack is used to fabricate one of a GAA FET, FinFET, ForkFET, CFET, or 2D structure.

10. The method of claim 1, wherein the first optical measurements and the second optical measurements further include strain, stress, and/or defects.

11. The method of claim 1, wherein the first optical measurements and the second optical measurements are performed at least partly simultaneously or sequentially.

12. (canceled)

13. A non-transitory computer-readable storage medium, comprising one or more programs for executing the following steps on one or more computing devices:
receiving first optical measurements that include a thickness of a film stack of a workpiece and a composition of the film stack measured using SE, SR, and/or ARR;
receiving second optical measurements that include the thickness of the film stack and the composition of the film stack measured using multiwavelength Raman spectroscopy;
combining the first optical measurements and the second optical measurements to form combined measured data, wherein the combining includes regressing the first optical measurements and the second optical measurements; and
determining the thickness of the film stack and the composition of the film stack using the combined measured data.

14. The non-transitory computer-readable storage medium of claim 13, wherein the combining further includes combining reference measurements with the first optical measurements and the second optical measurements.

15. The non-transitory computer-readable storage medium of claim 13, wherein the combining and the determining use a physical model.

16. The non-transitory computer-readable storage medium of claim 13, wherein the combining and the determining use a machine-learning algorithm.

17. The non-transitory computer-readable storage medium of claim 13, wherein the first optical measurements and the second optical measurements further include strain, stress, and/or defects.

18. A system comprising:
a measurement unit configured to measure a thickness of a film stack of a workpiece and a composition of the film stack using SE, SR, and/or ARR thereby generating first optical measurements;
a multiwavelength Raman spectroscopy unit configured to measure the thickness of the film stack and the composition of the film stack thereby generating second optical measurements; and
a processor in electronic communication with the the measurement unit and the multiwavelength Raman spectroscopy unit, wherein the processor is configured to:
combine the first optical measurements and the second optical measurements to form combined measured data, wherein the combining includes regressing the first optical measurements and the second optical measurements; and
determine the thickness of the film stack and the composition of the film stack using the combined measured data.

19. (canceled)

20. (canceled)

21. The system of claim 18, wherein the processor is further configured to combine reference measurements with the first optical measurements and the second optical measurements.

22. The system of claim 18, wherein the combining and the determining use a physical model and/or a machine-learning algorithm.

23. The system of claim 18, wherein the first optical measurements and the second optical measurements further include strain, stress, and/or defects.

24. The system of claim 18, wherein the first optical measurements and the second optical measurements are performed at least partly simultaneously or sequentially.

25. (canceled)

26. The method of claim 1, further comprising measuring the thickness of the film stack and the composition of the film stack using an x-ray technique thereby generating reference measurements, wherein the x-ray technique is x-ray diffraction (XRD), x-ray reflectometry (XRR), or a soft x-ray technique.

27. The method of claim 5, wherein the reference measurements use an x-ray technique, wherein the x-ray technique is XRD, XRR, or a soft x-ray technique.

28. The method of claim 1, wherein the thickness of the film stack includes thickness of one or more layers in the film stack.

29. The method of claim 7, wherein the machine-learning algorithm is trained on a theoretical model and/or measured data.

30. The non-transitory computer-readable storage medium of claim 13, further comprising receiving reference measurements that include the thickness of the film stack and the composition of the film stack measured using an x-ray technique, wherein the x-ray technique is XRD, XRR, or a soft x-ray technique.

31. The non-transitory computer-readable storage medium of claim 14, wherein the reference measurements use an x-ray technique, wherein the x-ray technique is XRD, XRR, or a soft x-ray technique.

32. The non-transitory computer-readable storage medium of claim 13, wherein the thickness of the film stack includes thickness of one or more layers in the film stack.

33. The non-transitory computer-readable storage medium of claim 16, wherein the machine-learning algorithm is trained on a theoretical model and/or measured data.

34. The system of claim 18, wherein the thickness of the film stack includes thickness of one or more layers in the film stack.

35. The system of claim 21, wherein the reference measurements use an x-ray technique, wherein the x-ray technique is XRD, XRR, or a soft x-ray technique.

36. The system of claim 22, wherein the machine-learning algorithm is trained on a theoretical model and/or measured data.
